(19) United States
(12) Patent Application Publication
(10) Pub. No.: US 2016/0162807 A1
(43) Pub. Date: Jun. 9, 2016

(54) Emotion Recognition System and Method for Modulating the Behavior of Intelligent Systems

(71) Applicant: CARNEGIE MELLON UNIVERSITY, a Pennsylvania Non-Profit Corporation, Pittsburgh, PA (US)

(72) Inventors: Asim Smailagic, Pittsburgh, PA (US); Daniel Siewiorek, Pittsburgh, PA (US)

(73) Assignee: CARNEGIE MELLON UNIVERSITY, a Pennsylvania Non-Profit Corporation, Pittsburgh, PA (US)

(21) Appl. No.: 14/960,335

(22) Filed: Dec. 4, 2015

Related U.S. Application Data
(60) Provisional application No. 62/123,986, filed on Dec. 4, 2014.

(51) Int. Cl. G06N 99/00; G06N 7/00

(52) U.S. Cl. CPC G06N 99/005; G06N 7/00

(57) ABSTRACT

The disclosure describes an audio-based emotion recognition system that is able to classify emotions in real-time. The emotion recognition system, according to some embodiments, adjusts the behavior of intelligent systems, such as a virtual coach, depending on the user's emotion, thereby providing an improved user experience. Embodiments of the emotion recognition system and method use short utterances as real-time speech from the user and use prosodic and phonetic features, such as fundamental frequency, amplitude, and Mel-Frequency Cepstral Coefficients, as the main set of features by which the human speech is characterized. In addition, certain embodiments of the present invention use One-Against-All or Two-Stage classification systems to determine different emotions. A minimum-error feature removal mechanism is further provided in alternate embodiments to reduce bandwidth and increase accuracy of the emotion recognition system.

### CROSS-REFERENCE TO RELATED APPLICATIONS

This application claims the benefit under 35 U.S.C. §119 of Provisional Ser. No. 62/123,986, filed Dec. 4, 2014, which is incorporated herein by reference.

### STATEMENT REGARDING FEDERALLY SPONSORED RESEARCH

This invention was made with government support under the National Science Foundation Number EEEC-0540865. The government has certain rights in this invention.

### BACKGROUND OF THE INVENTION

The invention relates generally to intelligent reactive systems. More specifically, the invention relates to a system and method that recognize the emotions of a user from auditory signals, allowing a response of an intelligent system to be adjusted based on the user's emotional state.

Emotions often drive human behavior and detection of the emotional state of a person is very important for system interaction in general and in particular in the design of intelligent systems, such as virtual coaches used in stroke rehabilitation, for example. As the virtual coach is used to improve the quality of life of a user, emotion recognition is an important facet of that intelligent system. A model of human behavior that can be instantiated for each individual includes emotional state as one of its primary components. Example emotional states that emotion recognition systems address are: anger, fear, happy, neutral, sadness and disgust.

The task of emotion recognition is a challenging one and has received immense interest from researchers. One prior method uses a supra-segmental Hidden Markov Model approach along with an emotion dependent acoustic model. This method extracts prosodic and acoustic features from a corpus of word tokens, and uses them to develop an emotion dependent model that assigns probabilities to the emotions—happy, afraid, sad, and angry. The label of the emotion model with the highest generating probability is assigned to the test sentence.

Other prior methods present an analysis of fundamental frequency in emotion detection, reporting an accuracy of 77.31% for a binary classification between ‘expressive’ or emotional speech and neutral speech. With this method, only pitch related features were considered. The overall emphasis of the research in this method was to analyze the discriminative power of pitch related features in contrasting neutral speech with emotional speech. The approach was tested with four acted emotional databases spanning different emotional categories, recording settings, speakers, and languages. There is a reliance on neutral models for pitch features built using Hidden Markov Models in the approach; otherwise, the accuracy decreases by up to 17.9%.

In other examples, automatic emotion classification systems and methods use the information about a speaker's emotion that is contained in utterance-level statistics over segmental spectral features. In yet another example, researchers use class-level spectral features computed over consonant regions to improve accuracy. In this example, performance is compared on two publicly available datasets for six emotion labels—anger, fear, disgust, happy, sadness, and neutral. Average accuracy for those six emotions using prosodic features on the Linguistic Data Consortium (LDC) dataset was 65.38%. Some research identifies the accuracy of human's emotion detection at 70%.

While these prior systems produce fairly good results, accuracy can be improved. Moreover, these prior systems do not approach real-time results and some do not provide recognition of an expanded set of emotions. It would therefore be advantageous to develop an emotion recognition system that provides accurate real-time classification for use in reactive intelligent systems.

### BRIEF SUMMARY OF THE INVENTION

According to embodiments of the present disclosure is an audio-based emotion recognition system that is able to classify emotions as anger, fear, happy, neutral, sadness, disgust, and other emotions in real time. The emotion recognition system can be used to adapt an intelligent system based on the classification. A virtual coach is an application example of how emotion recognition can be used to modulate intelligent systems' behavior. For example, the virtual coach can suggest that a user take a break if the emotion recognition system detects anger. The system and method of the present invention, according to some embodiments, rely on a minimum-error feature removal mechanism to reduce bandwidth and increase accuracy. Accuracy is further improved through the use of a Two-Stage Hierarchical classification approach in alternate embodiments. In other embodiments, a One-Against-All (OAA) framework is used. In testing, embodiments of the present invention achieve an average accuracy of 82.07% using the OAA approach and 87.70% with the Two-Stage Hierarchical approach. In both instances, the feature set was pruned and Support Vector Machines (SVMs) was used for classification.

The system of the present invention has the following salient characteristics: (1) it uses short utterances as real-time speech from the user; and (2) prosodic and phonetic features, such as fundamental frequency, amplitude, and Mel-Frequency Cepstral Coefficients are used as the main set of features by which the human speech samples are characterized. In relying on these features, the system and method of the present invention focus on using only audio as input for emotion recognition without any additional facial or text features. However, video features are used by the intelligent system to determine other aspects of the user's state. For example, in some embodiments, a video camera is used to determine if a stroke patient is performing physical exercises properly. The results of the video monitoring can be combined with the emotion recognition to adjust the feedback given to the user. In this manner, the intelligent system can adjust the interaction style, which encompasses the user's behavior, rather than react to the instant emotional state of the user. For example, on detecting the user's emotion as angry, the system advises the patient to ‘take a rest’ from performing the physical exercise.

The models of the present invention can classify several emotions. A subset of those emotions—anger, fear, happy and neutral—was chosen in some embodiments for the virtual coach application based on consultations with clinicians and physical therapists. Additional types of intelligent, reactive systems, such as but not limited to autonomous reactive robots and vehicles and intelligent rooms, will benefit from the emotion recognition system described herein.

### BRIEF DESCRIPTION OF THE SEVERAL VIEWS OF THE DRAWINGS

FIG. 1 is a block diagram of an intelligent system, according to one embodiment.

FIG. 2 shows a flow diagram of the feature extraction method, according to one embodiment.

FIG. 3 presents a flow diagram of the two-stage hierarchical classification framework.

FIG. 4 shows a flow diagram of the training method for each classifier.

FIG. 5 shows a flow diagram of the emotion recognition system integrated with an intelligent system, according to one embodiment.

FIG. 6 presents interaction dialog between a user and the intelligent system, such as a virtual coach, integrated with the emotion recognition system.

FIGS. 7A and 7B show screenshots of the user interface for the virtual coach intelligent system.

FIGS. 8A and 8B shows histograms of features for Anger vs. Fear classification.

FIG. 9 presents classification methodologies with highest accuracy and corresponding set of most discriminative features for the LDC dataset.

### DETAILED DESCRIPTION OF THE INVENTION

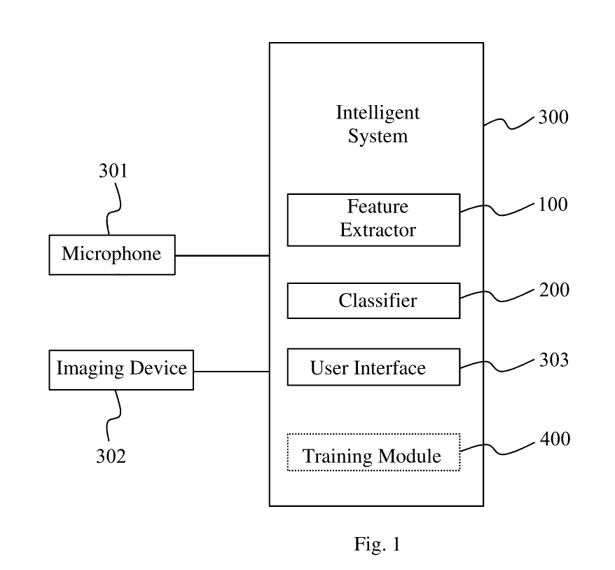

In one embodiment, the emotion recognition system comprises a feature extractor 100 and a classifier 200. The feature extractor 100 and classifier 200 are modules that are incorporated into the intelligent system 300. Alternatively, the feature extractor 100 and classifier 200 are integrated into a standalone emotion recognition system. In the preferred embodiment, the emotion recognition system is a computing device with the feature extractor 100 and classifier 200 comprising software or other computer readable instructions. Likewise, in the preferred embodiment, the intelligent system 300 is a computing device capable of executing instructions stored on memory or other storage devices. In this embodiment, the intelligent system comprises the feature extractor 100, classifier 200, a user interface 303 as software modules and an audio input 301 and imaging device 302, as shown in FIG. 1. A training module 400 can be included; alternatively, the training module 400 can be part of the classifier 200.

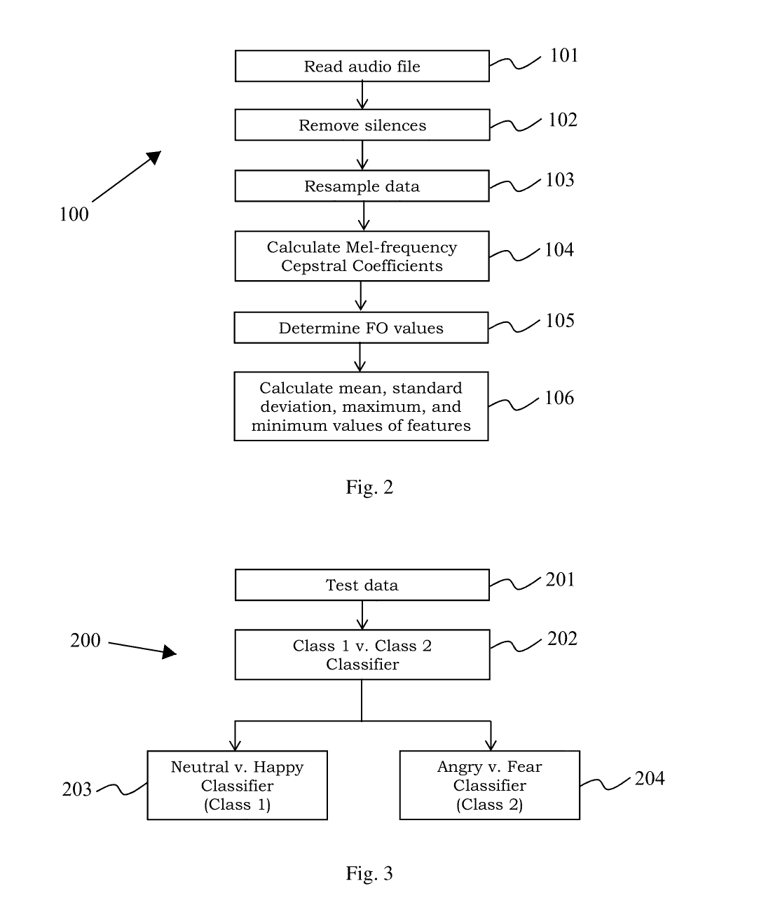

FIG. 2 is a flow diagram showing the method of feature extraction, according to one embodiment. At step 101, an audio file is read into the extractor 100. The audio file can be data derived from speech captured by a microphone 301 or other audio capture device connected to the emotion recognition system or intelligent system 300. At step 102, the silent portions of the audio file are removed. Removing the silent portions of the audio improves the speed and efficiency of the system by truncating the audio data file and discarding data that does not contribute to emotion recognition. Further, removal of intervals of silence from a speech signal and filters is done so that distortion from the concatenation of active speech segments is reduced. The speech signal plays faster because pauses are removed. This is useful in computing mean quantities related to speech in that it removes the pauses of silence between words and syllables, which can be quite variable between people and affect performance computations. Since the emotion recognition system analyzes prosodic and acoustic features from the given audio, the silences under a defined threshold have no information for the feature extraction.

As step 103, the audio data is resampled. At step 104, phonetic features, such as Mel Frequency Cepstral Coefficients (MFCC), are calculated. The coefficients are generated by binning the signal with triangular bins of increasing width as the frequency increases. Mel Frequency Cepstral Coefficients are often used in both speech and emotion classification. As such, a person having skill in the art will appreciate that many methods of calculating the coefficients can be used. In the preferred embodiment, a total of 42 prosodic and phonetic features are used. These include 10 prosodic features describing the fundamental frequency and amplitude of the audio data. The prosodic features are useful in real-time emotion classification because they accurately reflect the state of emotion in an utterance, or short segment of audio. By using utterances, it is not necessary for the emotion recognition system to record the content of the words being spoken.

At step 105, FO values are determined using a pitch determination algorithm based on subharmonic-to-harmonic ratios. The following acoustic variables are strongly involved in vocal emotion signaling: the level, range, and contour of the fundamental frequency (referred to as F0; it reflects the frequency of the vibration of the vocal folds and is perceived as pitch). For example, happy speech has been found to be correlated with increased mean fundamental frequency (F0), increased mean voice intensity and higher variability of F0, while boredom is usually linked to decreased mean F0 and increased mean of the first formant frequency (F1).

Using the prosodic and phonetic features together, as opposed to using only prosodic features, helps achieve higher classification accuracy. The approach of the present invention towards feature extraction focuses on the utterance-level statistical parameters such as mean, standard deviation, minimum, maximum and range. A Hamming window of length 25 ms is shifted in steps of 10 ms, and the first 16 Cepstral coefficients, along with the fundamental frequency and amplitude are computed in each windowed segment. Statistical information is then captured for each of these attributes across all segments.

At step 106, the mean and standard deviation are calculated for each of the 16 Cepstral coefficients providing 32 features. In addition, the mean, standard deviation, minimum, maximum and range were calculated for fundamental frequency and amplitude, thus providing the remaining 10 features. This results in 42 features for the dataset in the preferred embodiment. In alternate embodiments, the number of features extracted from the audio data can differ depending on the particular application in which the emotion recognition system is being used. For example, in application where low processing demands are prioritized, fewer features may be extracted.

Once the features are extracted, they are used to classify the speech. FIG. 3 is a flow diagram showing the general method of classification, according to the Two-Stage Hierarchical embodiment. In the two-stage classification, test data is input at step 201. Next, the data is classified into one of two categories of emotions at step 202. In the preferred embodiment, the first class comprises neutral and happy and the second class comprises angry and sad. If the data is classified into the first class, the second stage of classification recognizes the data as neutral or sad at step 203 in a first classifier 200. If the data is identified as belonging to the second class, then the next stage classifies the data as angry or sad at step 204 in a second classifier 200. Thus, the emotion recognition system contains three classifiers 200, one in the first stage and two classifiers 200 in the second stage.

For the purpose of classification, Support Vector Machines with Linear, Quadratic and Radial Basis Function kernels, are used due to the property of SVMs to generate hyperplanes for optimal classification. Depending on the particular application of the virtual coach, optimization can be run with different parameters for different kernels and the best performing model, along with its parameters, is stored for each classification to be used later with the virtual coach.

By way of example of the operation of the emotion recognition system, the performance of three classification methodologies were evaluated on the syntactically annotated audio dataset produced by Linguistic Data Consortium (LDC) and on a custom audio dataset.

1) LDC Audio Dataset

The primary dataset used for performance evaluation was the LDC audio dataset. The corpus contains audio files along with the transcripts of the spoken words as well as the emotions with which those words were spoken by seven professional actors. The transcript files were used to extract short utterances and the corresponding emotion labels. The utterances contained short, four-syllable words representing dates and numbers, e.g. ‘August 16th’. The left channel of the audio files was used after sampling the signal down to 16 kHz, on which classification algorithms were run.

The One-Against-All algorithm according to one embodiment classifies six basic emotions—anger, fear, happy, neutral, sadness and disgust. As such, the emotion classes from the LDC corpus corresponding to these six emotions were selected. Table I shows this mapping along with the number of audio files from the dataset corresponding to each of the six emotions. A total of 947 utterances were used.

TABLE I
Mapping of LDC emotions to six basic emotions.

| Basic Emotion | LDC Emotion | Number of utterances |
|---|---|---|
| Anger | Hot anger | 139 |
| Disgust | Disgust | 179 |
| Fear | Anxiety | 183 |
| Happy | Happy | 179 |
| Neutral | Neutral | 112 |
| Sadness | Sadness | 155 |

2) Banana Oil Dataset

This dataset is a custom created dataset to be used as an alternative to the LDC. 1,440 audio files were recorded from 18 subjects, with 20 short utterances for neutral, angry, happy and fear emotions in the context of the virtual coach application. Each audio file was 1-2 seconds long. The subjects were asked to speak the phrase “banana oil” exhibiting all four emotions. This phrase was selected because of its lack of association between the words and the emotions assayed in the study (i.e. anger or neutral), thereby allowing each actor to “act out” the emotion without any bias to the meaning of the phrase.

The subjects were given 15 minutes for the entire session, wherein they were made to listen to pre-recorded voices for two minutes, twice, after which they were given two minutes to rehearse and perform test recordings. In addition, for fear emotion, a video was shown as an attempt to incite that particular emotion. After recording the voice samples, subjects were asked if they felt the samples were satisfactory, and in case they were not, the recording was performed again for the unsatisfactory ones.

Finally, after all samples had been recorded, they were renamed to conceal the corresponding emotion labels. For the purpose of emotional evaluation, seven ‘evaluators’ listened to the samples at the same time, and each one independently noted what she felt was the true emotion label for that particular file. Throughout this process, the labels from one evaluator were not known to the rest. Finally, a consensus of labels was taken for each file, which was then decided as the ground truth label for that particular file. In addition, the consensus strength was also determined, based on the ones with the strongest consensus which were used for the final dataset of 464 files, 116 for each emotion. The evaluators were fluent speakers of English language.

While the focus of the emotion recognition system is to classify varying emotions, it is also desirable to concentrate on classifying positive (happy/neutral) against negative emotions (anger/fear) in the context of virtual coach for stroke rehabilitation. Therefore, the emotion recognition system operates with two distinct classifiers 200, namely a One-Against-All (OAA) and Two-Stage Hierarchical classification.

To create each classifier 200, the system must be trained. In one training method, a 10-fold cross-validation approach is used on the training set for model, and files corresponding to each emotion are grouped randomly into 10 folds of equal size. Finally, the results are accumulated over all 10 folds, from which a confusion matrix is calculated. The results over all passes were combined by summing the entries in the confusion matrices from each fold.

With the One-Against-All approach, the classifier 200 is trained to separate one class from the remaining classes, resulting in six such classifiers 200, one for each emotion when six emotions are being classified. This can result in an imbalance in the number of training examples for positive and negative classes, depending on the training data set used. In order to remove any bias introduced by this class imbalance, the accuracy results from the binary classifier 200 were normalized over the number of classes to compute balanced accuracy.

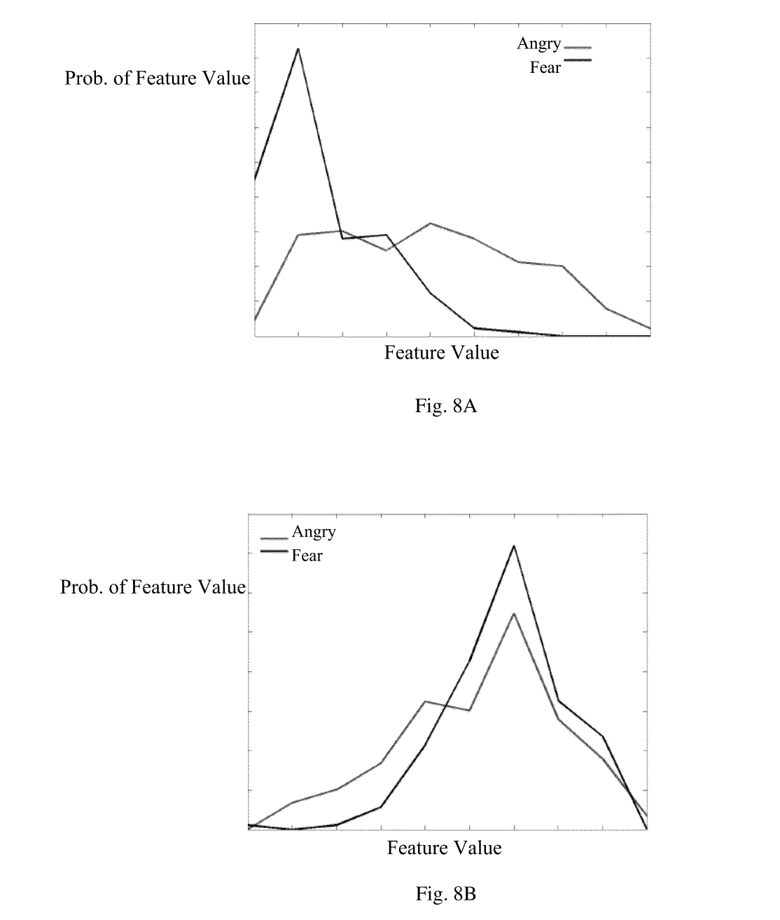

For the Two-Stage classifier 200, a confusion matrix obtained from a 4-emotion classification exhibited relatively less confusion in the emotion pairs Neutral-Happy and Angry-Fear, as compared to the four other pairs. In addition, thorough observation of feature histogram plots for all four emotions revealed that some features were able to sufficiently discriminate between certain emotions, while not being able to do so for the rest, and vice versa. FIGS. 8A and 8B are examples of a first feature that clearly discriminates between the emotions of anger and fear (FIG. 8A) and second feature that shows a large overlap between these two emotions (FIG. 8B).

Recognizing the overlap shown in FIG. 8B, the emotion recognition system employs a model which achieves high classification accuracy across the emotions by performing a classification cascade between different sets of emotions, thereby resulting in the two-stage classifier 200. Referring again to FIG. 3, in this framework, the first stage determines if the emotion detected was a positive one (Class1), i.e. Neutral or Happy, or a negative emotion (Class2), i.e. Anger or Fear. Depending on the result of the first stage, the emotion would then either be classified as Neutral or Happy, or as Anger or Fear by separate classifiers 200 in the second stage.

To further improve accuracy, the emotion recognition system employs a feature reduction mechanism. In the preferred embodiment, the feature extractor generates 42 features, consisting of 32 Cepstral, 5 pitch, and 5 amplitude features. However, some of the features do not add any information for the purpose of distinguishing between different emotions or emotion classes. Therefore, features are ranked based on their discriminative capability, with the aim of removing the low ranked ones. Histogram plots for each feature indicate that, for most cases, the distribution within each class could be approximated by a unimodal Gaussian. Referring again to FIGS. 8A-8B, the plots show histograms of two features for Anger-versus-Fear classification, one with high (FIG. 8A) and low (FIG. 8B) discriminative ability, respectively.

In order to quantify the discriminative capability of each feature, a parameter M is defined for classes i and j, such that M(i,j) is the percentage of files in class j that occupy values inside the range of values from class i with i≠j.

For a feature having values distributed over k classes, there would be a matrix M of size k×(k−1), where each row contained the overlap values between a particular class and each of the (k−1) remaining classes. The lesser the overlap a feature offered, the higher was its discriminative capability. Depending on the type of classification to be performed, the appropriate average overlap was calculated.

For Anger-versus-Rest classification, the average overlap was calculated as shown in Equation (1).

$$Overlap = \frac{1}{l} {\sum }_{j} M ( anger , j ) \\ where j ∈ \{ neutral , happy , fear \} , l = \vert j \vert \qquad ( 1 )$$

For a Class1-versus-Class2 classification, where Class1 consists of Neutral and Happy, and Class2 consists of Angry and Fear, the overlap was calculated as shown in Equation (2).

$$Overlap = \frac{1}{k \times l} {\sum }_{i} {\sum }_{j} M ( i , j ) \\ where i ∈ \{ neutral , happy \} , j ∈ \{ anger , fear \} , k = \vert i \vert , l = \vert j \vert \qquad ( 2 )$$

Thus, for a given classification problem, features are first ranked in decreasing order of discriminative ability, and the ones with the worst discriminative power are successively removed, the classification trial is run with a reduced set each time.

While the method is conceptually similar to feature selection methods such as Minimum-redundancy-maximum-relevance (mRMR), which makes use of mutual information from a feature set for a target class, it is significantly different in the following ways.

First, the focus is on feature removal, not on feature selection. This means that the method of the present invention concentrates on discarding features that do not contribute enough towards classification, rather than finding the set of features that contributes best to classification. Additionally, mutual information is symmetric and averaged over all classes, while Overlap M is asymmetric and specific to a pair of classes, i.e. M(i,j)≠M(j,i). Thus, the present invention can find a feature's discriminative power for classification between any set of classes. This mechanism of feature removal reduces bandwidth and increases accuracy of the emotion recognition system.

In the preferred embodiment, feature paring is speaker independent. However, in alternate embodiments, feature paring can be based on age, gender, dialect, or accents. Consideration of these variables in the feature removal process has the potential to increase accuracy of the emotion recognition system.

The feature removal feature can be implemented as part of the training for each classifier 200. In the preferred embodiment, each classifier 200 is trained separately. For example, in the Two-Stage Hierarchical classifier 200, a first classifier 200 will distinguish between class 1 and class 2 emotions and is trained specifically for making this determination. That is, the classifier 200 will use the best features that discriminate class 1 utterances from class 2 utterances. A second classifier 200 will distinguish between neutral and happy emotions, while the third classifier 200 will distinguish between angry and fear emotions, with the second and third classifiers 200 each being trained separately.

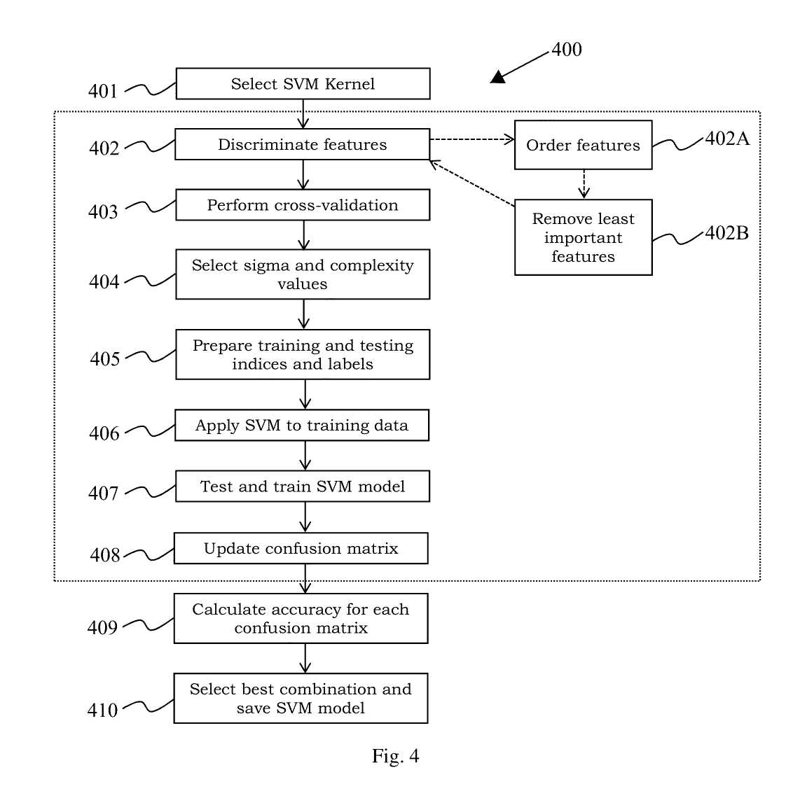

FIG. 4 is a flow diagram showing the classifier training method, according to one embodiment. Training can be based on individual speakers, or it can be speaker independent. For example, an emotion recognition system used in a virtual coach for stroke rehabilitation could be speaker independent since many different patients will be using the system. Alternatively, the system could be trained specifically for the patient if the system were their personal system.

As shown in step 401, first a SVM model is selected. Next, at step 402, the features are pared based on the discriminative ability. According to the method described above, as part of the discrimination process the features are ordered based on their discriminative ability at step 402A. Next, the least important features are removed at step 402B. At step 403, cross-validation is performed. During step 404, the sigma and complexity values are selected. For example, values of each can be sigma: {1e⁻², 1e⁻¹, 1, 5, 10} and complexity: {1e⁻², 1e⁻¹, 2+1e⁻¹, 5+1e⁻¹, 1}. For each sigma value and each complexity value: the training and testing indices are prepared at step 405, the kernel is applied to the training data at step 406, the model is tested and trained at step 407, and the confusion matrix is updated at step 408. Next, the accuracy for each confusion matrix is calculated at step 409. At step 410, the best combination is selected and the SVM model is saved.

The binary classification has its highest accuracy associated with a unique set of features. The complete set consisted of the mean of the first 16 Cepstral coefficients followed by the standard deviation of those coefficients and the mean, maximum, minimum, standard deviation and range of the fundamental frequency and the amplitude, respectively. Analysis of the best feature set for each classifier suggests two important things. The highest cross-validation accuracy for all emotions except fear emotion was obtained when the least discriminative features were pruned. The One-Against-All classifier for fear vs. rest used all 42 features. Additionally, amplitude features, except the mean value, are not discriminative enough for problems involving neutral and disgust emotions, particularly for One-Against-All classification.

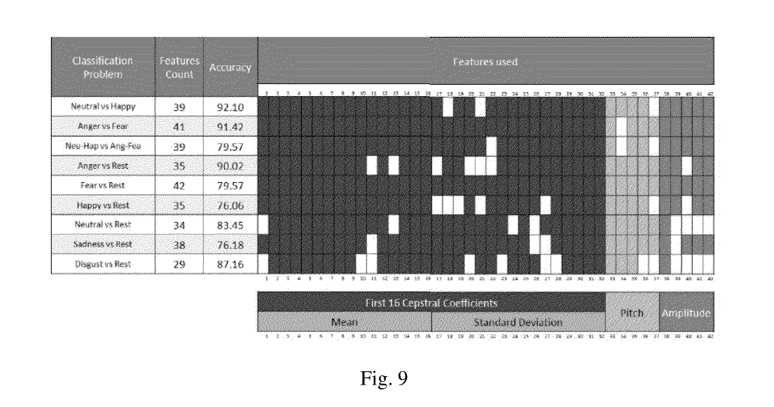

The classification accuracy and the associated feature set for different classification problems are summarized in FIG. 9, where a shaded bar indicates that the particular feature was used, while the absence indicates that the feature was pruned. The table shows that, for most of the cases, the best accuracy is achieved when the number of least discriminative features is removed for the LDC dataset.

In One-Against-All classification, the average classifier 200 accuracy was found to be 82.07%, while in the two-stage classification framework, the average accuracy was 87.70%. For Anger vs. Fear and Class 1 vs. Class 2 classification tasks, SVM with quadratic kernels gave the best results, whereas RBF kernels performed best for the rest of the trials. Table II shows the accuracy results for One-Against-All classification and those of a prior art system using OAA classification for a six-class recognition task.

A comparison of the results for One-Against-All classification with those of a different classification system shows that the method of the present invention achieves higher average accuracy, as shown in Table III. The Banana Oil dataset was used in this trial.

TABLE II
Emotion recognition accuracies on the LDC dataset

| Emotion | Prior Art (%) | Present Invention (%) |
|---|---|---|
| Anger | 71.9 | 90.02 |
| Fear | 60.9 | 79.57 |
| Happy | 61.4 | 76.06 |
| Neutral | 83.8 | 83.45 |
| Sadness | 60.4 | 76.18 |
| Disgust | 53.9 | 87.16 |

TABLE III
Emotion recognition accuracies on the Banana Oil dataset

| Emotion | Prior Art (%) | Present Invention (%) |
|---|---|---|
| Anger | 77.9 | 87.90 |
| Fear | 60.0 | 86.13 |
| Happy | 93.8 | 87.70 |
| Neutral | — | 91.40 |

As one non-limiting example of a system of the present invention, the emotion recognition system is applied in an intelligent system 300 used to facilitate stroke rehabilitation exercises. The virtual coach evaluates the user's exercises and offers corrections for rehabilitation of stroke survivors. The virtual coach for stroke rehabilitation exercises is composed of an imaging device 302 (Microsoft Kinect sensor, for example) for monitoring motion, a machine learning model to evaluate the quality of the exercise, and a user interface 303 comprised of a tablet for the clinician to configure parameters of exercise. A normalized Hidden Markov Model (HMM) was trained to recognize correct and erroneous postures and exercise movements.

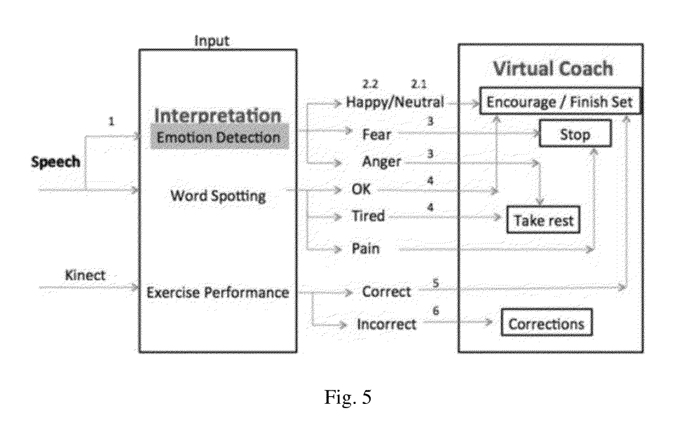

Coaching feedback examples include encouragement, suggesting taking a rest, suggesting a different exercise, and stopping all together. For example, as shown in FIG. 5, if the user's emotion is classified as angry, the system advises the user to ‘take a rest’. While the emotion recognition system does not analyze the content of the speech, the intelligent system 300 can include a word spotting feature to further assist adjusting to the user's behavior. As shown in FIG. 5, word spotting can include identification of words such as “OK,” “Tired,” and “Pain.”

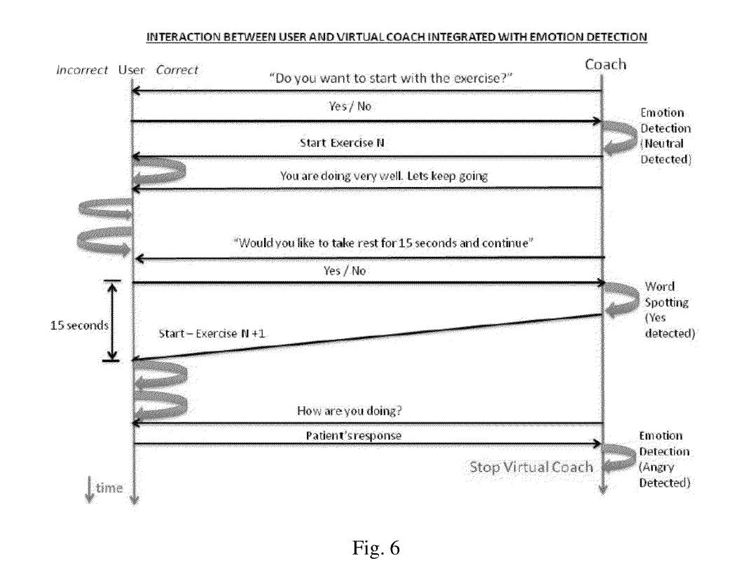

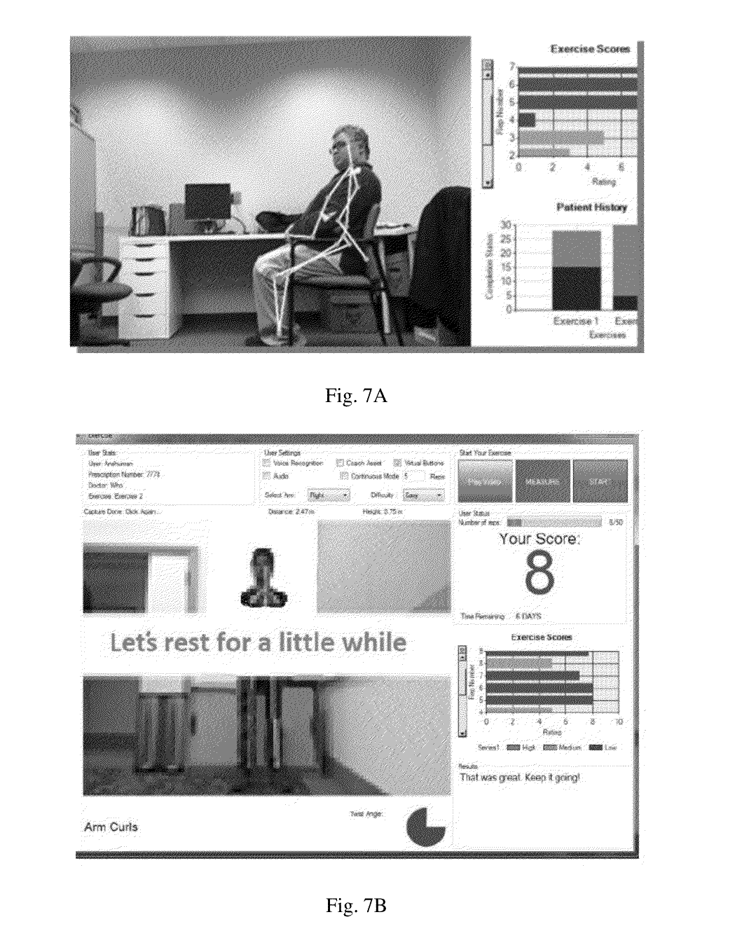

An interactive dialog can be added to elicit responses from the user, as shown in FIG. 6. Based on these responses, the emotion is gauged by the audio emotion recognizer. The coaching dialog changes depending on performance, user response to questions, and user emotions. FIG. 7A depicts a patient using the virtual coach, while FIG. 7B illustrates the situation when the system recognizes the user emotion as angry, and advises the user to ‘take a rest’.

In addition to a virtual coach, the emotion recognition system can be incorporated into other intelligent systems 300, such as autonomous reactive robots, reactive vehicles, mobile phones, and intelligent rooms. In all of these examples, the intelligent systems 300 will benefit from the emotion recognition system described herein. For intelligent systems 300 where the primary purpose of the device or system is not emotion recognition, such as a mobile phone, a speech trigger can be used to detect the onset of speech or a specific command that initiates the emotion recognition sequence. The speech trigger would save battery life since the emotion recognition system would not be running during periods when it was not being utilized.

While the disclosure has been described in detail and with reference to specific embodiments thereof, it will be apparent to one skilled in the art that various changes and modification can be made therein without departing from the spirit and scope of the embodiments. Thus, it is intended that the present disclosure cover the modifications and variations of this disclosure provided they come within the scope of the appended claims and their equivalents.

What is claimed is:

1. A method of adjusting an intelligent system based on the emotion of a user, comprising:
obtaining audio data based on speech from a user of the intelligent system;
extracting a plurality of features from the audio data;
classifying the audio data based on one or more of the plurality of features,
wherein an emotion associated with the speech is assigned to the audio data; and
modifying instructions generated by the intelligent system based on the emotion.

2. The method of claim 1, wherein extracting a plurality of features comprises:
reading the audio data;
calculating a set of Mel-frequency Cepstral coefficients from the audio data;
determining a set of FO values from the audio data; and
calculating a mean, standard deviation, maximum, and minimum from the set of FO values.

3. The method of claim 2, further comprising:
removing portions of the audio data corresponding to silences in the speech; and
resampling the audio data.

4. The method of claim 1, wherein the emotion is selected from the group consisting of happiness, neutrality, anger, fear, sadness, and disgust.

5. The method of claim 1, wherein classifying the audio data comprises:
classifying the audio data into a first class or a second class in a first stage classification,
wherein the first class comprises positive emotions,
wherein the second class comprises negative emotions;
assigning the audio data to one of two second stage classifiers based on the first stage classification; and
classifying the audio data in a second stage classification.

6. The method of claim 1, further comprising:
training a classifier to classify the audio data.

7. The method of claim 6, wherein training the classifier comprises:
selecting a support vector machine kernel to generate a classification model;
discriminating the plurality of features;
performing a cross-validation of the discriminated features to generate a confusion matrix associated with the model;
selecting sigma and complexity values;
preparing training and testing indices and labels;
applying the support vector machine kernel to the training data;
testing and training the model;
updating the confusion matrix for the model;
calculating the accuracy of the confusion matrix; and
saving the model based on the discriminated features and the updated confusion matrix.

8. The method of claim 7, wherein discriminating the plurality of features comprises:
ordering the plurality of features based on an ability of each feature to discriminate the audio data into one of a plurality of emotions; and
removing a lowest ranked feature.

9. An intelligent system for generating prompts based on the emotions of a user, the intelligent system comprising:
an audio capture device for generating audio data;
a processor; and
a set of executable instructions stored on memory, the instructions comprising:
a feature extraction module, and
a classification module;
wherein the processor executes the instructions to:
extract a plurality of features from the audio data;
classify the audio data with an emotion using at least a portion of the plurality of features.

10. The intelligent system of claim 9, further comprising:
an image capture device for generating video data;
a second set of executable instructions comprising a motion evaluator;
wherein the processor executes the second set of instructions to:
identify a motion performed by the user as correct or incorrect.

11. The intelligent system of claim 10, further comprising:
a user interface,
wherein the user interface displays instructions to the user,
wherein the instructions are based on the identification of the motion and the emotion classification.
